(19) United States
(12) Patent Application Publication
(10) Pub. No.: US 2002/0018172 A1
(43) Pub. Date: Feb. 14, 2002

(54) Method for manufacturing a flat panel display using localized wet etching

(76) Inventor: James J. Alwan, Ramona, CA (US)

Correspondence Address: RAJESH VALLABH, ESQ., HALE & DORR, LLP, 60 STATE STREET, BOSTON, MA, 02109, US

(21) Appl. No.: 09/775,920

(22) Filed: Feb. 2, 2001

Related U.S. Application Data
(60) Provisional application No. 60/181,619, filed on Feb. 10, 2000.

(51) Int. Cl. G02F 1/13

(52) U.S. Cl. 349/187

(57) ABSTRACT

A method is provided for locally etching certain structures formed in outer peripheral areas of field emission devices. The structures include alignment marks and bond pads, which require removal of materials deposited on the structures during manufacture.

### RELATED APPLICATION

This application is based on Provisional U.S. Application Ser. No. 60/181,619 filed Feb. 10, 2000 and entitled “Method For Manufacturing A Flat Panel Display Using Localized Wet Etching”.

### GOVERNMENT RIGHTS

This invention was made with Government support under Contract No. ______ awarded by the Advanced Research Projects Agency (ARPA). The Government has certain rights in the invention.

### FIELD OF THE INVENTION

The present invention relates generally to flat panel displays and, more particularly, to field emission devices (“FEDs”) and methods for manufacturing the same.

### BACKGROUND OF THE INVENTION

FIG. 1 is a simplified illustration of a portion of a known FED device 10. As is well known, FED technology operates on the principle of cathodoluminescent phosphors being excited by cold cathode field emission electrons.

In general, the FED device 10 comprises a cathode panel assembly 6 and an anode panel assembly 8 separated from each other by spacers 4. The cathode assembly 6 has a substrate or baseplate 12 on which a thin conductive structure 14 is formed. The thin conductive structure 14 may be formed from doped polycrystalline silicon that is deposited on the baseplate. It is usually formed on the baseplate 12 in strips that are electrically connected. Strips 14a, 14b and 14c are shown in FIG. 1. The number of strips needed for a particular device will depend on the size and the desired performance of the FED device. Collectively, the electrically connected strips serve as the emitter electrode.

A resistive layer (not shown) of, e.g., amorphous silicon, may be deposited on top of the conductive strips 14. At predetermined sites on the resistive layer (if present) and strips 14, a pattern of spaced-apart conical cold cathode emitters or micropoints 18 is formed. In FIG. 1, a single micropoint 18 is shown on the illustrated portion of the strip 14a, a row of four micropoints 18 is shown on the strip 14b between the spacers 4, and a single micropoint 18 is shown on the illustrated portion of the strip 14c.

After the micropoints have been formed on the emitter electrode strips, a dielectric insulating layer is deposited over the micropoints 18 and the emitter electrode strips 14. The insulating layer, which is later formed into an insulating structure 20, may comprise silicon dioxide. Next, a conductive layer is deposited over the insulation layer. This conductive layer, which is formed into an extraction structure 22, may be made from a variety of materials including chromium, molybdenum, or doped polysilicon. Then using a photolithographic process, the insulating layer and the conductive layer are etched to form the insulating and extraction structures 20, 22, respectively, which surround, but are spaced away from the micropoints 18 as shown in FIG. 1. The extraction structure 22 forms a low potential anode that is used to extract electrons from the micropoints 18.

The anode assembly 8 has a transparent (e.g., glass) substrate 24 and a transparent conductive layer 26 formed over the substrate 24 (on the side thereof facing cathode assembly 6). A black matrix grill 25 is formed over the conductive layer 26 to define pixel regions, and a cathodoluminescent coating (e.g., a red, green or blue phosphor, designated 28r, 28g and 28b, respectively) is deposited in the defined pixel regions of the grill 25. One purpose of the black matrix grill 25 is to provide improved contrast in the FED display. In some cases, the black matrix grill 25 is omitted and the red, green and blue phosphors simply deposited on the proper predetermined regions of the bottom surface of the conductive layer 26.

The anode assembly 8 is typically manufactured by depositing successively defined features on the lower (as shown in FIG. 1) surface of the transparent substrate 24, starting with transparent conductive layer 26. The next features to be formed are the spacers 4, which project downwardly (e.g., about 150 microns) from conductive layer 26. The black matrix grill 25 is then formed using a photolithographic process to define the “holes” or pixel regions. In color displays, each pixel usually has three holes, each for one of red, green and blue phosphors. Red, green and blue phosphors are deposited into respective holes in three successive steps. In each step, a photolithographic process leaves open only one of the holes of each set of three holes, and the desired color phosphor is then deposited into the “open” hole. Finally, a protective binder (not shown) is typically coated over the entire phosphor/matrix surface.

The anode assembly 8 is positioned a predetermined distance from cathode assembly 6 and from micropoint emitters 18 by spacers 4.

A power supply 30 is electrically coupled to the conductive layer 26 of the anode assembly 8 and to the conductive layers 14 (under the micropoint emitters 18) and 22 (of the gate electrode) of the cathode assembly 6. A vacuum in the space between cathode 6 and anode 8 permits electrons emitted from the micropoints 18 to travel towards and impact the phosphor layer 28. The emitted electrons strike cathodoluminescent coating 28, which emits light to form a video image on a display screen created by anode 8.

Multiple photolithography sequences are typically used to fabricate the fine features of the various structures (e.g., the micropoints) on the cathode and anode assemblies 6, 8. Photolithography is commonly carried out in a tool known as a “stepper.” A typical photolithography sequence is as follows. A substrate having a layer of film to be patterned is covered with a layer of photoresist and placed on a stage in the stepper. A mask, which contains the pattern that is to be replicated on the device, is placed above the device. The mask dimensions are usually larger than the dimensions to be printed onto the photoresist, and a series of reducing lenses focus the pattern to the size desired for printing on the photoresist. In the case of a transmissive mask, the mask pattern is created by transmissive and absorbing material portions arranged in a pattern on the mask. When light of a selected wavelength is applied to the mask, the “transmissive” portions of the mask, which are transparent to the selected wavelength, allow the light to pass through the mask. The “absorbing” portions of the mask, which are opaque to and absorb the selected wavelength, block the light transmission. The pattern on the mask is thereby replicated onto the photoresist on the device. At high resolutions, only a small portion of the device is patterned at a time. The stepper “steps” the device a small distance for subsequent patterning. Once exposure of the device has been completed, the photoresist on the device is developed by rinsing in a solution that dissolves selected portions of the photoresist to create a pattern in the photoresist matching the pattern of the mask. Following, photolithography, the entire device is etched. The pattern in the photoresist is typically etched into the underlying material on the device (using, e.g., wet etching or plasma etching), resulting in a transfer of the pattern in the photoresist to the underlying material. The remaining photoresist is then stripped from the device.

In addition to being used to fabricate the various fine structures and features of FEDs, photolithography/etch/strip sequences are also used for other less critical purposes such as clearing alignment marks and bond pads. These photolithography processes are costly, complex and time consuming. Therefore, it is desirable to reduce the number of these processes in FED manufacturing.

Micron Technology, Inc. has developed certain equipment used specifically in the field of semiconductor wafer fabrication for the purpose of clearing alignment marks. The equipment includes nozzles that selectively spray a wet etchant over the alignment marks while limiting application of the etchant over other parts of the wafer. The equipment thereby allows alignment marks to be cleared without the use of photolithography. It is desired to use such techniques to reduce the number of photolithography steps in FED manufacturing.

### BRIEF SUMMARY OF THE INVENTION

One object of the present invention is to provide a method of manufacturing a flat panel display device including localized removal of material covering certain structures in the device.

Another object of the invention is provide a method of manufacturing an FED having a reduced number of photolithography/etch/strip sequences.

These and other objects are accomplished by a method of manufacturing a flat panel display device in which there is localized removal of materials covering certain structures in the device such as, e.g., bond pads and alignment marks. The localized material removal is preferably performed by selectively spraying wet etchant over the structures to be uncovered and restricting spraying of the etchant elsewhere. The inventive process reduces the number of photolithography/etch/strip sequences needed in making the device, thereby lowering the cost of manufacture and cycle time.

These and other objects and advantages of the present invention will become readily apparent from the following detailed description wherein embodiments of the invention are shown and described by way of illustration of the best mode of the invention. As will be realized, the invention is capable of other and different embodiments, and its several details may be capable of modifications in various respects, all without departing from the invention. Accordingly, the drawings and description are to be regarded as illustrative in nature and not in a restrictive or limiting sense with the scope of the application being indicated in the claims.

### BRIEF DESCRIPTION OF THE DRAWINGS

For a fuller understanding of the nature and objects of the present invention, reference should be made to the following detailed description taken in connection with the accompanying drawings in which like reference numerals are used to indicate the same or similar parts wherein:

FIG. 1 is a cross-section view of a portion of an exemplary prior art FED;

FIG. 2 is a plan view of an FED in an intermediate stage of production having an active central area and a peripheral area with alignment marks, which are uncovered in accordance with one aspect of the invention; and

FIG. 3 is a plan view of an FED in an intermediate stage of production showing bond pads in a peripheral area of the FED, which are uncovered in accordance with another aspect of the invention.

### DETAILED DESCRIPTION OF THE PREFERRED EMBODIMENTS

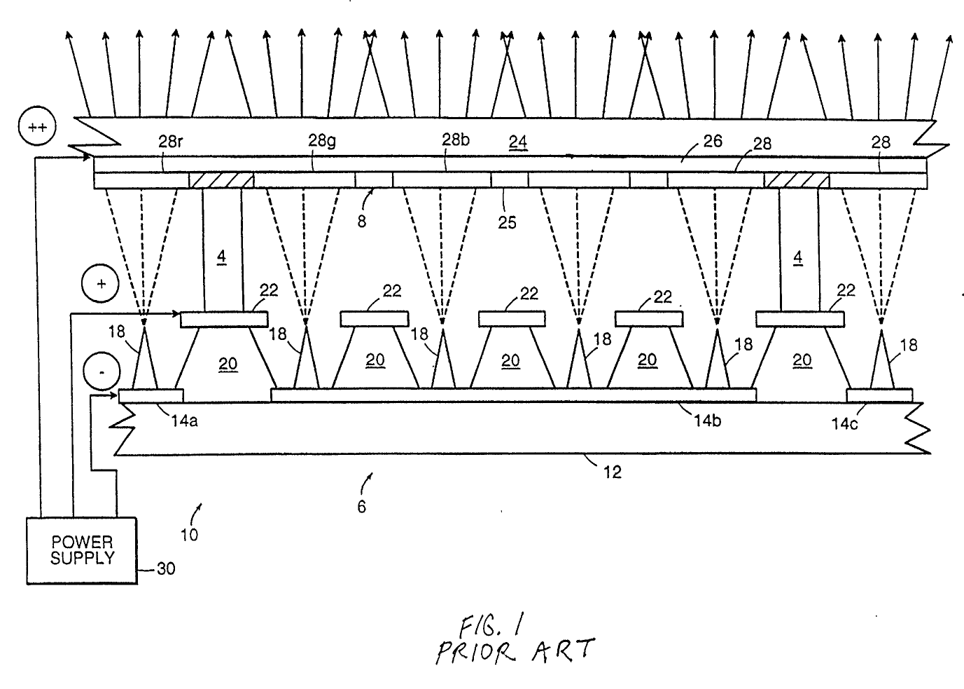

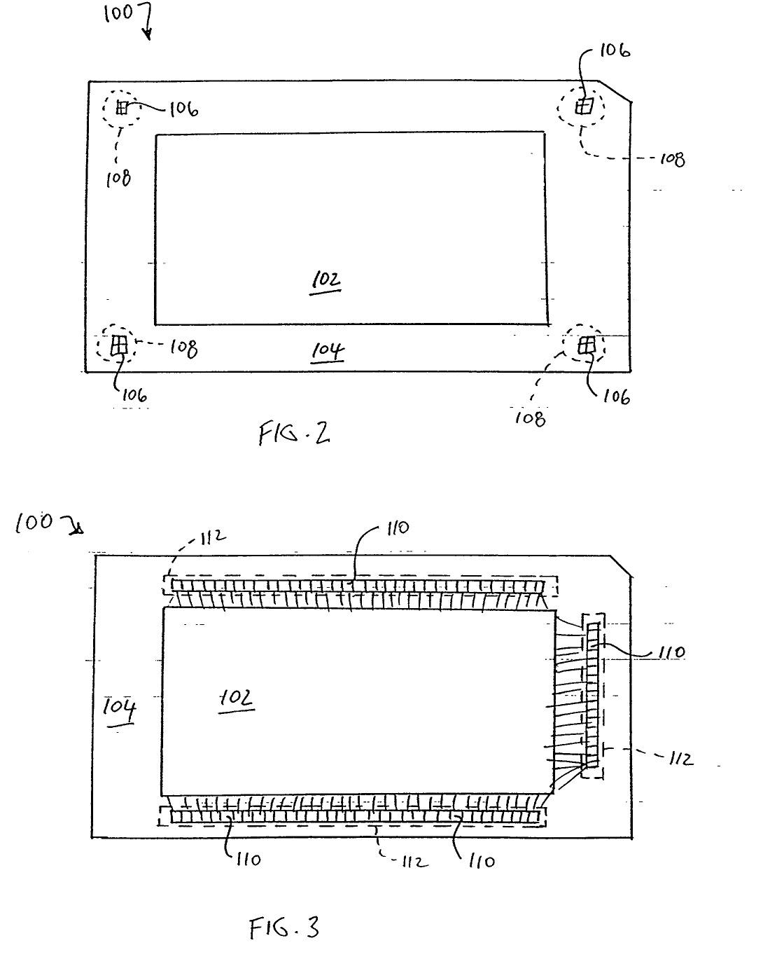

The present invention is directed to an improved method of manufacturing FEDs. FIG. 2 illustrates either one of the anode or cathode panel assemblies indicated generally at 100 of an FED in an intermediate stage of manufacture. The panel 100 includes a central active area or region 102 containing the display array components such as, e.g., micropoints. (A representative portion of the central region of an FED is shown in FIG. 1.) The panel 100 also includes a peripheral or outer area 104 surrounding the central active area 102. The peripheral area 104 typically contains larger structures not requiring the stringent process controls needed in making the structures of the active central area.

Structures on the peripheral area include, e.g., lithography and/or assembly alignment marks 106. These marks usually made on FED substrates are used by steppers to precisely align different masks used in sequential photolithographic steps. During FED fabrication, after certain processes, the alignment marks become obscured and unreadable. For example, after certain layers from which structures are to be formed are deposited on the panel and the layers are polished by, e.g., chemical-mechanical planarization (CMP) processes, the deposited material is planarized over and, thereby covers and occludes the alignment marks. For instance, in the manufacture of FED 10 of FIG. 1, after the insulation and conduction layers 20, 22 are deposited over the micropoints 18, a CMP process of the layers will planarize materials like oxide and silicon over the alignment marks. As a result, the appearance of the alignment marks is changed, typically rendering the marks unrecognizable by alignment systems designed to use them.

It is therefore important to remove these deposited layers and recover the topology of the marks to enable recognition by alignment systems. In conventional FED manufacturing, a full panel lithograph/etch/strip sequence is performed to selectively remove the deposited layers on the alignment marks. While this process adequately uncovers the marks, it is a costly, time consuming and complex process.

In accordance with one aspect of the present invention, a localized etch is performed to clear the alignment marks 106 without photolithography. In the inventive process, localized etching is performed on only the alignment marks on the peripheral area of the panel, leaving the remainder of the FED, including the central active area 102, unetched. The localized etching is preferably performed by spraying wet etchant over the alignment marks, e.g., in zones indicated in phantom by reference numeral 108. The localized etch is applied on the marks preferably using nozzles positioned above the marks, which spray the etchant. Because the alignment marks 106 are located in the peripheral region 104, even if application of the spray zone 108 is off by 200 microns or so, the etching process to clear the alignment marks will still generally succeed. (By contrast, an error of this magnitude in the active central region 102 will usually result in a defective product because of the higher resolution of the structures in this region.) Referring to FIG. 3, in accordance with another aspect of the invention, bond pads 110 in the peripheral area 104 of the cathode assembly are cleared using localized etching. Bond pads 110 are used as the terminals for electrically connecting active circuits in the FED to external circuits. During fabrication of the FED, the bond pads are covered by insulating oxide and nitride passivation layers that must eventually be removed. In conventional FED fabrication, a full panel photolithography/etch/strip sequence is performed to selectively etch the bond pads to remove the passivation layers. As previously discussed, photolithography processes are costly and time consuming. In accordance with the present invention, localized etching is selectively performed on the bond pads, leaving the remainder of the panel including the central active array region unetched. This process advantageously avoids the need for a costly photolithography/etch/strip sequence for clearing the bond pads.

To perform the localized etching of the bond pads, wet etchant is preferably applied on the bond pads in elongated spray zones 112 in the peripheral area 104 of the panel 100. To form the elongated spray zones 112, the etchant is preferably sprayed from a nozzle as it is moved linearly over the panel. Alternatively, the nozzle can be held stationary and the panel moved relative to the nozzle to create the spray zone.

Etch chemistries for removing oxide, nitride, and silicon and other substances are generally well known. For example, oxide and nitride can be removed with a buffered HF solution, while silicon can be etched with a mixture of nitric acid, HF, acetic acid, and water. Some selectivity may be needed for etching the bond pads, depending on bond pad material. For instance, if the bond pad comprises aluminum, a surfactant treatment with the etchant may be needed.

Having described embodiments of the present invention, it should be apparent that modifications can be made without departing from the scope of the present invention.

1. In a method for manufacturing a flat panel display device, a method for selectively removing material covering a structure in the device comprising locally applying an etchant on the material covering the structure.

2. The method of claim 1 wherein the structure comprises a bond pad.

3. The method of claim 1 wherein the structure comprises an alignment mark.

4. The method of claim 1 wherein locally applying an etchant comprises providing a localized spray of wet etchant over the structure.

5. The method of claim 1 wherein locally applying an etchant comprises applying said etchant along an elongated zone over a plurality of structures.

6. The method of claim 5 wherein applying said etchant along an elongated zone comprises spraying a wet etchant from a nozzle while moving one of the nozzle and the device relative to the other.

7. The method of claim 1 wherein the device includes a central active region and an outer region, and wherein the structure is located in the outer region.

8. In a method of making a field emission device having a central active display area and a peripheral area surrounding the active display area, a method of removing a layer of material covering a component located in the peripheral area comprising selectively directing an etchant on the layer of material covering the component in the peripheral area without directing etchant toward the active display area.

9. The method of claim 8 wherein the component comprises a bond pad and the layer of material comprises a passivation layer.

10. The method of claim 8 wherein the component comprises an alignment mark.

11. The method of claim 8 wherein selectively directing an etchant comprises locally spraying etchant on the layer of material covering the component.

12. The method of claim 8 wherein said central active display area comprises a high resolution area.

13. A method of making an FED, comprising: making a cathode assembly, making an anode assembly, and assembling said cathode and anode assemblies, wherein said step of making a cathode assembly includes the step of locally applying an etchant to uncover a structure in a peripheral of the cathode assembly.

14. The method of claim 13 wherein said structure comprises an alignment mark.

15. The method of claim 13 wherein said structure comprises a bond pad.

16. The method of claim 13 wherein said step of locally applying an etchant comprises spraying a wet etchant on the structure without spraying the etchant elsewhere.

17. A method of making an FED, comprising: making a cathode assembly, making an anode assembly, and assembling said cathode and anode assemblies, wherein said step of making an anode assembly includes the step of locally applying an etchant to uncover a structure in a peripheral region of the cathode assembly.

18. The method of claim 17 wherein said structure comprises an alignment mark.

19. The method of claim 17 wherein said step of locally applying an etchant comprises spraying a wet etchant on the structure while limiting spraying of the etchant elsewhere.

20. A method of forming a cathode assembly of an FED, comprising:
providing a substrate having a central area and a peripheral area;
forming alignment marks on the peripheral area of the substrate;
forming an emitter electrode structure on the central area of the substrate;
forming a plurality of micropoints in groups on the emitter electrode structure;
depositing an insulating layer over the substrate, emitter electrode structure, and plurality of micropoints;
depositing a conductive layer over the insulating layer;
locally applying etchant on the alignment marks; and
selectively etching openings through the conductive and insulating layers to expose the micropoints, with walls defining the openings being spaced away from the micropoints.

21. The method of claim 20 wherein selectively etching openings through the conductive and insulating layers comprises applying a layer of photoresist on said conductive layer, imaging said photoresist to define a pattern for said openings, developing the photoresist, and etching the pattern for the openings.

22. The method of claim 21 further comprising the step of polishing the conductive layer after the step of depositing a conductive layer over the insulating layer.

23. The method of claim 22 wherein said step of polishing comprises chemical-mechanical planarization.

24. The method of claim 21 wherein said step of locally applying an etchant comprises spraying a wet etchant on the alignment marks without spraying the etchant elsewhere.

25. A method of forming a cathode assembly of a field emission device, comprising:
providing a substrate;
making alignment marks in a peripheral region of the substrate;
forming an emitter electrode structure on a central region of the substrate, said central region being substantially surrounded by the peripheral region;
forming a plurality of micropoints on the emitter electrode structure;
depositing an insulating layer over the substrate, emitter electrode structure, and plurality of micropoints;
depositing a first conductive layer over the insulating layer;
polishing the conductive layer;
selectively applying localized etchant on the alignment marks while inhibiting application of the etchant on the central region to clear the marks of material deposited thereon; and
etching openings through the conductive and insulating layers to expose the micropoints, with walls defining the openings being spaced away from the micropoints.

26. The method of claim 25 wherein said step of selectively applying a localized etchant comprises spraying a wet etchant on the alignment marks.

27. In a method for manufacturing a flat panel display having a central active display region and a peripheral region at least partly surrounding the active region, a process for removal of material covering a structure located in the peripheral region, comprising selectively spraying a wet etchant in localized fashion over the structure while limiting spraying of the etchant on the central active region, and thereafter rinsing residual etchant from the device.

28. The method of claim 27 wherein the structure comprises a bond pad.

29. The method of claim 27 wherein the structure comprises an alignment mark.

30. The method of claim 27 wherein said step of spraying a wet etchant comprises spraying said etchant along an elongated zone over a plurality of structures.

31. The method of claim 30 wherein said step of spraying said etchant along an elongated zone comprises spraying said etchant from a nozzle and moving one of said nozzle and said field emission display relative to the other.

32. The method of claim 27 wherein said flat panel display comprises a field emission device.
